(19) United States
(12) Patent Application Publication
(10) Pub. No.: US 2026/0161558 A1
(43) Pub. Date: Jun. 11, 2026

(54) SYSTEMS AND METHODS FOR ADDRESS MAPPING OF A MEMORY DEVICE

(71) Applicant: Samsung Electronics Co., Ltd., Suwon-si (KR)

(72) Inventors: Ilgu Hong, Santa Clara, CA (US); Hyoun Kwon Jeong, Pleasanton, CA (US); Younghoon Kim, San Diego, CA (US); Yangwook Kang, San Jose, CA (US)

(21) Appl. No.: 19/414,103

(22) Filed: Dec. 9, 2025

Related U.S. Application Data
(60) Provisional application No. 63/730,274, filed on Dec. 10, 2024.

(51) Int. Cl. G06F 12/06

(52) U.S. Cl. CPC G06F 12/06; G06F 2212/70

(57) ABSTRACT

Systems and methods for address mapping of a memory device are disclosed. An apparatus includes a memory device organized into memory units. The memory addresses of the memory device are interleaved across the memory units. The apparatus also includes a processing engine associated with a memory unit and a set of channels. A size of the memory unit is based on the number of the channels. The processing engine may: receive a request associated with an artificial intelligence (AI) operation, the request including a memory address; identify, based on the memory address, a memory location defined by physical memory components of the memory device, wherein the memory location is contained in the first memory unit; retrieve data from the memory device based on the memory location via one or more of the set of channels; and perform the AI operation based on the data retrieved from the memory device.

### CROSS-REFERENCE TO RELATED APPLICATION(S)

The present application claims priority to and the benefit of U.S. Provisional Application No. 63/730,274 filed Dec. 10, 2024, entitled “ADDRESS MAPPING SCHEME FOR NEAR MEMORY COMPUTATION WITH PES WHICH OWN DEDICATED HBM CHANNEL,” the entire content of which is incorporated herein by reference. The present application is also related to U.S. application Ser. No. 19/251,777, entitled “SYSTEM AND METHOD FOR DATA PLACEMENT FOR MATRIX MULTIPLICATION,” filed on Jun. 26, 2025, the entire content of which is incorporated herein by reference.

### FIELD

One or more aspects of embodiments according to the present disclosure relate to memory devices, and more particularly to systems and methods for address mapping of a memory device.

### BACKGROUND

The use of artificial intelligence (AI) has increased dramatically over the last few years. Using AI often necessitates the use of large datasets and advanced algorithms and that similarly necessitate efficient and cost-effective data processing solutions.

The above information disclosed in this Background section is only for enhancement of understanding of the background of the present disclosure, and therefore, it may contain information that does not form prior art.

### SUMMARY

One or more embodiments of the present disclosure are directed to an apparatus that includes a memory device organized into a plurality of memory units, and a first processing engine associated with a first set of channels configured to access the memory device. The memory addresses of the memory device are interleaved across the memory units. The first processing engine is associated with a first memory unit of the plurality of memory units. A size of the first memory unit is based on a number of channels in the first set of channels. The first processing engine is configured to: receive a request associated with an artificial intelligence (AI) operation, the request including a first memory address; identify, based on the first memory address, a memory location defined by physical memory components of the memory device, wherein the memory location is contained in the first memory unit; retrieve data from the memory device based on the memory location via one or more of the first set of channels; and perform the AI operation based on the data retrieved from the memory device.

In some embodiments, the size of the first memory unit is based on a number of active rows of the memory device.

In some embodiments, the size of the first memory unit is based on a page size of one of the active rows.

In some embodiments, the AI operation invokes a matrix multiplication.

In some embodiments, the memory device includes two or more memory dies configured to be vertically stacked on top of each other.

In some embodiments, a second processing engine is associated with a second memory unit. The second memory unit has a second memory address greater than the first memory address by a size of the memory unit.

In some embodiments, the first memory address is mapped to one or more fields of the memory location defined by the physical memory components. The fields include at least one of an offset field, a bank group field, a column field, and a channel field.

In some embodiments, the one or more fields have locations relative to each other to control access of first columns in a first row relative to access of second columns in a second row.

In some embodiments, the one or more fields have locations relative to each other to provide interleaved row access across bank groups.

In some embodiments, the one or more fields have locations relative to each other to provide interleaved channel access across the first set of channels.

One or more embodiments are also directed to a method that includes: receiving, by a processing engine, a request associated with an artificial intelligence (AI) operation, the request including a first memory address, wherein the first processing engine associated with a first set of channels configured to access a memory device, wherein the memory device is organized into a plurality of memory units, wherein memory addresses of the memory device are interleaved across the memory units, and wherein the first processing engine is associated with a first memory unit of the plurality of memory units, wherein a size of the first memory unit is based on a number of channels in the first set of channels; identifying, based on the first memory address, a memory location defined by physical memory components of the memory device, wherein the memory location is contained in the first memory unit; retrieving data from the memory device based on the memory location via one or more of a first set of channels; and performing the AI operation based on the data retrieved from the memory device.

As a person of skill in the art should recognize, the interleaving of the memory addresses across the memory units based on the number of the channels of a processing engine allows the processing engine to access the memory units via the designated channels instead of, for example, side channels.

These and other features, aspects and advantages of the embodiments of the present disclosure will be more fully understood when considered with respect to the following detailed description, appended claims, and accompanying drawings. Of course, the actual scope of the invention is defined by the appended claims.

### BRIEF DESCRIPTION OF THE DRAWINGS

Non-limiting and non-exhaustive embodiments of the present embodiments are described with reference to the following figures, wherein like reference numerals refer to like parts throughout the various views unless otherwise specified.

FIG. 1 depicts a block diagram of a system of a memory device with compute capability for near memory computing according to one or more embodiments;

FIG. 2 depicts a conceptual layout diagram of address mapping for a memory system according to one or more embodiments;

FIG. 3 depicts a bit map for mapping a memory address of a memory unit into a location of physical memory components according to one or more embodiments;

FIG. 4 depicts a mapping of example memory addresses to locations of physical memory components based on the bit map of FIG. 3 according to one or more embodiments;

FIG. 5 depicts a flow diagram of a process for memory access by a processing engine according to one or more embodiments;

FIG. 6 depicts a conceptual layout diagram of a matrix multiplication according to one or more embodiments; and

FIG. 7 depicts a conceptual layout diagram of a tile encoding process according to one or more embodiments.

### DETAILED DESCRIPTION

Hereinafter, example embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, descriptions thereof may not be repeated. Further, in the drawings, the relative sizes of elements, layers, and regions may be exaggerated and/or simplified for clarity.

Embodiments of the present disclosure are described below with reference to block diagrams and flow diagrams. Thus, it should be understood that each block of the block diagrams and flow diagrams may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (for example the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flow diagrams. Accordingly, the block diagrams and flow diagrams support various combinations of embodiments for performing the specified instructions, operations, or steps.

In addition, a feature of embodiments of the present disclosure may be combined or combined with one or more other features, partially or entirely, and may be operated in various ways, and an embodiment may be implemented independently of one or more other embodiments, or in conjunction with the one or more other embodiments.

The use of AI has increased for different types of applications and domains such as image classification, speech recognition, media analytics, heath care, autonomous machines, smart assistants, and the like. Substantially large amounts of data may be transferred between a computational logic (e.g., a graphical processing unit (GPU) or central processing unit (CPU)) and a memory device, to allow these applications to perform associated AI operations and computations. The transfer of data between the computational logic and the memory device may consume power (e.g., relatively large amounts of power), bandwidth, and/or the like.

One way to address the power consumption problem is to move some or all of the AI computation to a computational logic near a memory that stores the data used for the computation. The resulting near memory computation may reduce the volume of traffic between the GPU/CPU, as the GPU/CPU may not need to retrieve the large amount of data to perform the computations, but receive the results of the computations from the computational logic.

In general terms, embodiments of the present disclose relate to the use of computational logic (referred to as a processing engine) near a memory device to perform computations for an application running on a host computing device. The application may be an artificial intelligence (AI) application. The AI application may perform AI operations, such as, for example, inference operations. During an inference process by an AI application, computations of data (e.g., large amounts of data) may be carried out. In some embodiments, the computations may be performed with reduced power consumption and data access latency by controlling the storage of data in specific memory locations of the memory device. In this regard, the processing engine may have a set (e.g., associated or dedicated) memory channels that allow access to corresponding memory locations with increased data throughput. In some embodiments data used for computation by a processing engine is placed in consecutive memory locations that are accessible to the processing engine via the associated memory channels. The storing of the data in this manner may reduce the use of a side memory channels that increases latency.

In some embodiments, the address space of the memory device accessed by one or more of the processing engines may be interleaved so that consecutive memory addresses are spread across multiple memory modules or memory units that have a set size. In this regard, the address space may be divided into the smaller memory units, and memory addresses may be assigned in an interleaved manner across the memory units. The interleaved memory assignment may allow for more efficient and even data distribution across the processing engines.

In some embodiments an address mapping scheme is used for mapping the address of a memory unit to a location of physical memory components of the memory device. The memory device may include a high bandwidth memory (HBM) composed of physical memory components such as one or more channels, banks, bank groups, rows, and columns. Each bank may be composed of multiple rows, and each row may have multiple columns. The address mapping scheme may be configured to place data in a location of physical memory component that is identified by a specific channel, bank group, row, and column so to reduce power consumption and latency when the data is accessed by the processing engines during a computation. In this regard, in order to access a specific memory address, a row associated with the address is activated by applying charge power to the row, before accessing a column of the activated row. In some embodiments, the memory mapping scheme reduces power consumption and latency by placing data sequentially in a memory unit in columns on a same row. The processing engine associated with the memory unit may then retrieve the data by accessing the columns of the row before using power to activate another row.

In some embodiments, the address mapping scheme increases bandwidth via interleaved bank group access and/or interleaved channel access. In this regard, column-to-column delay in a same bank group that share the same computing resources may be greater than the delay across bank groups that do not share the same resources. By utilizing an address mapping scheme that interleaves row access across bank groups, bandwidth may be increased. In a similar manner, channel interleaving where computing resources are not shared from channel to channel may help increase bandwidth for a data access operation.

In some embodiments, tiled matrix multiplications may also face the problem of increased power consumption during a computation. To perform a tiled matrix multiplication, multiple rows of the tile may need to be activated to access the data stored in the tile. One or more embodiments of the present disclosure include a tile encoding mechanism to serialize the elements of the tile matrix and save the elements in one or more memory units in a continuous address space. In this manner a processing engine may retrieve the elements of the tile from the memory units via serialized column access commands where columns of an activated row may be accessed prior to accessing another row. The serialized column access may consume less power than multiple row accesses.

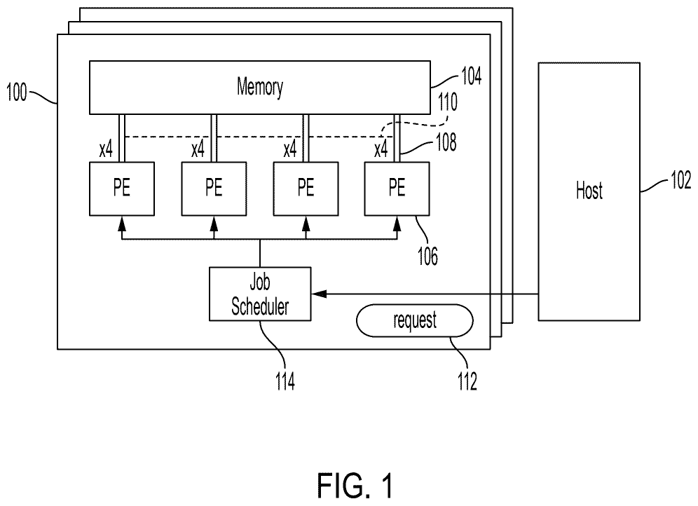

FIG. 1 depicts a block diagram of a system of a memory device with compute capability for near memory computing according to one or more embodiments. In some embodiments, the system includes one or more memory devices 100 coupled to a host computing device (“host”). The host may communicate with the memory devices 100 to offload to the memory devices 100, certain types of data-intensive computations such as, for example, convolution operations for a machine-learning or AI model. The convolution operations may include matrix multiplications that are used by the machine-learning model to make inferences or predictions such as, for example, image classifications, text predictions, and the like, based on a received input.

In some embodiments, the memory device 100 includes a memory 104 and one or more processing engines (PEs) 106 near the memory. The processing engines 106 and the memory 104 may integrated onto a single chip for near memory computing, to reduce data movement between the memory and the PEs and reduce energy consumption. In some embodiments, the memory device 100 is implemented as a high-bandwidth memory (HBM) device.

The memory 104 may be a 3-D stacked memory that includes two or more memory dies that may be vertically stacked on top of each other over a buffer die. The memory dies may be implemented as DRAMs. However, the present invention is not limited thereto, and the memory dies may be implemented as any suitable memory that may be implemented in a 3D-stacked structure.

The PEs 106 may be configured to perform computations or operations based on a request 112 from an application running in the host 102. The computations may be, for example, matrix multiplications involving relatively large matrices used for machine learning inference operations, although embodiments are not limited thereto, and may include other computations or operations of the application. One or more of the PEs 106 may include a processing circuit such as, for example, a general matrix multiplication engine (GEMM engine), or the like, to perform the requested computations.

In some embodiments, the PEs 106 are incorporated into the buffer die (not shown). In order to perform the computations requested by the host, the PEs 106 may store and load data to and from the memory 104. In some embodiments, a PE 106 is assigned to dedicated memory channels 108 to store and load the data to the memory 104. For example, four memory channels may be dedicated or assigned to a PE 106. Access of the memory 104 via the dedicated channels 108 may be at a relatively low latency compared to access of the memory via side channels 110 that are connected to a crossbar switch. Thus, it may be desirable to store data that is used by a PE, in the memory locations assigned to the dedicated channels of the PE.

In some embodiments, the memory space that is associated or bound to a PE 106 via the dedicated channels 108 may be mapped to an address space (e.g., a logical or physical address space) of the memory 104 so that the addresses are assigned to the memory space in an interleaved manner based on a memory unit having a set memory unit size. In some embodiments, the size of the memory unit is configured to be the size of the memory channels (e.g., 4 channels) assigned (e.g., dedicated) to a PE 106. In this regard, the memory 104 is divided into the smaller memory units, and the smaller memory units are allocated to a PE 106. The smaller memory units, referred to as a PE unit (PU), may be accessed by the PE via the dedicated memory channels. The interleaved PE address space based on the PU size may allow the distribution (e.g., stride) of data across the PEs 106 so that consecutive memory addresses may be spread across the PEs based on the PU size. For example, if the PU size is 16 kilobytes (KB), 16 KB of data addressed by a first memory address is stored in a first memory unit (e.g., associated with a first PE), and the next 16 KB of data addressed by a second memory address is stored in a next memory unit (e.g., associated with a second PE). The PEs may thus access the data stored in the corresponding PU with reduced power consumption via the dedicated memory channels, and may further engage in processing (e.g., concurrent processing) of the data with reduced wait times and increased throughput.

In some embodiments, the memory device 100 includes a job scheduling engine 114 configured to receive the request 112 from the host 102, and distribute the request and associated data to the one or more PEs 106. The job scheduling engine 114 may be implemented via software, firmware, hardware, or a combination of software, firmware, and/or hardware. A person of skill in the art should recognize, however, that the job scheduling engine 114 is optional, and the host may transmit the request to a PE 106, and the PE may execute a kernel (e.g., a binary code) for processing the request. In this regard, the PE 106 may identify, based on the request, a physical address of the memory 104 that is to be accessed, and load or store data to the physical address via a corresponding dedicated channel 108.

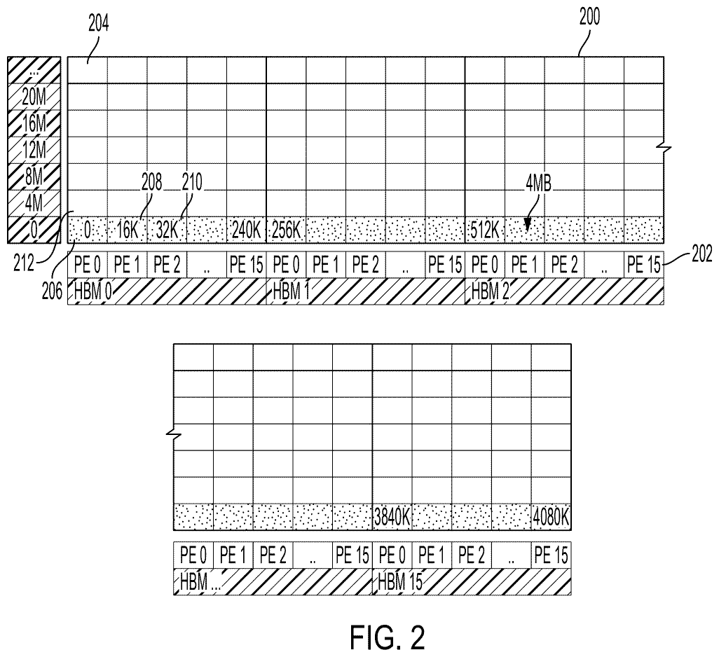

FIG. 2 depicts a conceptual layout diagram of address mapping for a memory system according to one or more embodiments. The memory system in the example of FIG. 2 includes 16 memory 200 devices (e.g., HBM 0-HBM 15), each with 16 processing elements (PEs) 202 (PE 0-PE 15), although embodiments are not limited thereto. The memory 200 may be similar to the memory 104 of FIG. 1, and the PEs 202 may be similar to the PEs 106 of FIG. 1.

In some embodiments, the memory 200 is divided or organized into blocks or memory units (PUs) 204 having a preset size. For example, the preset size may be 16 kilobytes (KB) that may correspond to the channels allocated to a PE. One or more of the PUs 204 may be allocated to a respective one of the PEs 202. In some embodiments, the addresses of the memory 104 may be interleaved based on the size of the PU. For example, assuming that the size of a PU is 16 KB, a start address of a first PU 206 assigned to a first PE (PE 0) is 0, a second start address of a second PU 208 assigned to a second PE (PE 1) is 16 KB, a third start address of a third PU 210 assigned to a third PE (PE 2) is 32 KB, and so on, for the first 4080 KB addresses.

The PUs 204 associated with the PEs 202 may be assigned a next set of 4080 KB addresses. For example, PU 212 associated with PE 0 is assigned a start memory address of 4 MB (or 4080 KB). In this manner, the memory addresses may be assigned across the PUs to allow contiguous memory reads and writes to use each PU in turn.

In some embodiments, the size of the PU 204 for the interleaved memory may depend on the configuration of the memory 200. For example, the memory 200 may be structured into channels, banks, bank groups, rows, and columns. Each bank may be a two-dimensional grid of memory cells composed of rows and columns. To access data, power is charged to the row of memory cells containing the data, and a specific column of the row is accessed. In some embodiments, data (e.g., a memory page) from the columns of the activated row are stored in a row buffer.

In some embodiments, the size of PU 204 is selected based on the configuration of the memory 200 to increase bandwidth, reduce latency, and reduce energy consumption for accesses to the memory. For example, the size of the PU 204 may depend on the number of channels 108 dedicated to a PE 202, a page size of an active row, a total number rows that may be active at a time, and/or the like. The page size may determine the amount of data that is loaded at a time into the row buffer, and may depend on the number of columns per active row, and number of bytes contained per column. For example, if there are 32 columns per active row, and each column contains 32 bytes of data, the page size is 1 KB (32 columns'32 bytes=1 KB). In an example memory device 100 that has 4 channels per PE 106 and 4 active rows at a given time per channel, the size of the PU 204 may be 16 KB (4 channels×4 active rows×1 KB page size=16 KB).

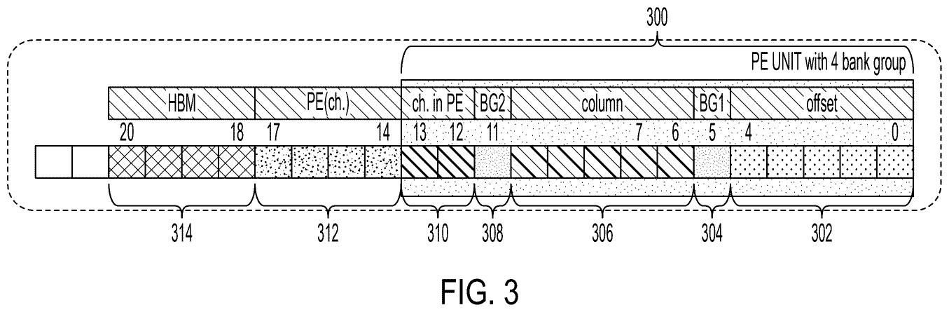

FIG. 3 depicts a bit map for mapping a memory address (e.g., a logical or physical memory address) of a PU 204 into a location of physical memory components (e.g., channel, bank group, bank, row, and column) of the memory 104 according to one or more embodiments. In some embodiments, in order to reduce row activation power, the bit map is configured to place data across columns of a row before placing the data in a different row. In this regard, a series of column bits of the bit map may be sequentially placed next to one another to cause sequential access and placement of data across the columns of a row before accessing another row.

When the data is to be accessed from the memory 104 for a computation, the row is activated to access the data from the row via sequential column access commands. Although activating the row may consume power and incur a latency, once the row is activated, accessing data from the columns in the row may be relatively fast.

In some embodiments, the bit map is further configured to provide for interleaved row access across bank groups, and provide interleaved channel access across the channels dedicated to a PE 106. In some embodiments, the bank group bits are placed above an offset field to allow the switching of the bank group for one or more (e.g., each) column access command that accesses the 32 bytes (e.g. a page) of the data identified by the offset fields, to avoid a column-to-column access. In this regard, successive column accesses within the same bank group may face greater latency than an access across a different bank group. The column-to-column latency, also referred to as column access (CAS)-to-CAS delay (CCD_t), may be due to a minimum number of clock cycles that are expended between two consecutive column read or write commands directed to different columns on the same row, even if the row is already activated. Because the access of a column in a separate memory bank may be initiated without the need to wait for completion of a column access in a current memory bank, the latency to access the separate memory bank may be less than the column access delay.

Interleaved channel access (e.g., between the channels assigned to a particular PE 106) may further allow for improved bandwidth as the channels may not share resources (e.g., row buffers) with one another. In some embodiments, the channel bits are placed above the column bits to provide access of the channels in sequence after accessing the available columns and the available bank groups. Channel interleaving may allow data access requests to be spread across the channels. Thus, latency of accessing a channel may be hidden by initiating read or write operations on a next channel without waiting for a memory access operation to finish on a prior channel.

In some embodiments, the address of a PU 204 is mapped to a location of physical memory components of the memory device 100 based on PU location bits 300. The number of PU location bits 300 may correspond to the PU size. For example, fourteen (14) PU location bits 300 are used to represent the PU size of 16 KB. The PU location bits 300 may identify different fields of the physical address including an offset field 302, a first bank group field 304, a column field 306, a second bank group field 308, and a channel field 310. The bit map may also map an address to a specific PE 106 based on the PE field 312, to a specific HBM based on the HBM field 314, and the like. The bit map may also include other fields such as, for example, a row field and a third bank group field (not shown) if the memory device supports additional memory banks.

The number of bits assigned to each field may be based on the configuration of the memory 104. For example, the bit map of FIG. 3 assumes that the memory 104 has 64 channels, each channel has 4 bank groups, each bank group has 4 banks, each row has 32 columns, and that 32 bytes may be accessed per column of an active row based on a column access command. In this regard, the channel field 310 may include 2 bits (for identifying 4 channels), the column field 306 may include 5 bits (for identifying 32 columns), the bank group 304, 308 may include two bits (for identifying 4 bank groups), and the offset field 302 may be 5 bits (for identifying 32 bytes of a column).

In some embodiments, the location of the one or more fields relative to one another may control the store and load of data to and from the various memory locations of the memory 104. For example, in order to reduce power consumption due to a row activation, the address mapping may place data for a PE 106 sequentially in an associated PU 204 across the columns of a same row. In this regard, the bit map of FIG. 3 includes a series of column bits 306 that are sequentially placed next to one another to cause sequential access of the columns of a row before accessing another row, to reduce row activation power consumption.

In some embodiments, the first bank group field 304 and second bank group field 308 are placed above the offset field 302. Such placement of the bank group fields 304, 306 allows the switching of the bank group for one or more (e.g., each) column access command that accesses the 32 bytes (e.g. a page) of the data identified by the offset fields 302. The switching of bank groups per column access command may reduce the column-to-column latency that may be encountered when switching between columns in the same bank group.

In some embodiments, the channel field 310 is placed above the column field 306 for providing interleaved channel access for the set of channels assigned to a PE 106. In this regard, the channels assigned to a PE 106 may the accessed in sequence per channel ID after accessing the available columns and the available bank groups. Channel interleaving may allow data access requests to be spread across the channels for increasing memory bandwidth and throughput.

In some embodiments, the interleaving of addresses across PEs 106 is controlled by the placement of the PE field 312 above the PU location bits 300. In this manner, data is stored in a PU of a first PE before moving to the PU of a next PE.

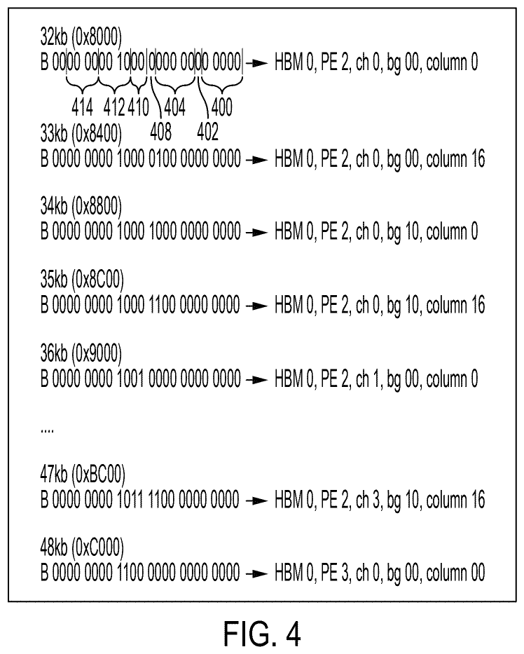

FIG. 4 depicts a mapping of example memory addresses to locations of physical memory components based on the bit map of FIG. 3 according to one or more embodiments. For ease of understanding, it is assumed that the address of the memory device 100 starts from 0, and that the PE address space is interleaved as in the memory system of FIG. 2, based on a PU size of 16 KB.

In the example of FIG. 4, a PU with memory address of 32 KB (0x8000) is mapped to PE 2 and has a corresponding binary address of 0000 0000 1000 0000 0000 0000. Based on the bit map of FIG. 3, bits 400 (00000) correspond to the offset field 302, bit 402 (0) corresponds to the first bank group field 304, bits 404 (00000) correspond to the column filed 306, bit 408 (0) corresponds to the second bank group field 308, bits 410 (00) correspond to the channel field 310, bits 412 correspond to the PE field 312, and bits 414 correspond to the HBM field 314. In this example, the location of the physical memory components that is mapped to the memory address of 32 KB is HBM 0, PE 2, channel 0, bank group 00, and column 0.

Similarly, memory address of 33 KB (0x8400) has a binary address of 0000 0000 1000 0100 0000 0000 that maps to HBM 0, PE 2, channel 0, bank group 00, and column 16.

Memory address of 34 KB (0x8800) has a binary address of 0000 0000 1000 1000 0000 0000 that maps to HBM 0, PE 2, channel 0, bank group 10, and column 0.

Memory address of 35 KB (0x8C00) has a binary address of 0000 0000 1000 1100 0000 0000 that maps to HBM 0, PE 2, channel 0, bank group 10, and column 16.

Memory address of 36 KB (0x9000) has a binary address of 0000 0000 1001 0000 0000 0000 that maps to HBM 0, PE 2, channel 1, bank group 00, and column 0.

Memory address of 47 KB (0xBC00) is a last memory address for PE 2, and has a binary address of 0000 0000 1011 1100 0000 0000 that maps to HBM 0, PE 2, channel 3, bank group 10, and column 16.

Memory address of 48 KB (0xC000) is a first address of a next PU that corresponds to PE 3, and has a binary address of 0000 0000 1100 0000 0000 0000 that maps to HBM 0, PE 3, channel 0, bank group 00, and column 0. As it can be appreciated via these examples, the PE memory addresses are interleaved based on the PU size to distribute data across the PEs and to reduce power consumption and latency for the memory accesses.

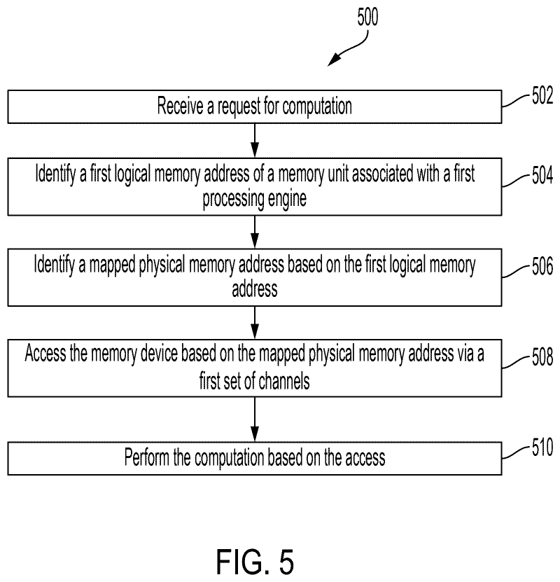

FIG. 5 depicts a flow diagram of a process 500 for memory access by a first processing engine (e.g., the PE 106) according to one or more embodiments. The process starts, and in act 502, the first processing engine receives a request associated with an AI operation from the host 102. The request may include, for example, a request for matrix multiplication to perform a prediction or an inference operation by an AI application running on the host 102. The prediction or inference operations may include image classifications for self-driving vehicles, text predictions for providing responses to queries by a chatbot, and/or the like.

In act 504, the first processing engine identifies, based on the request, a first memory address of a memory unit (e.g., the PU 204) associated with the first processing engine.

In act 506, the first processing engine identifies a location of physical memory components based on the first memory address. In some embodiments, the physical memory addresses are interleaved based on the size of the memory unit. The size may be determined based on one or more factors configured to reduce power consumption/or latency in accessing the memory device. For example, the size of the memory unit may be based on a number of channels that the first processing engine uses to access the memory device. In another example, the size of the memory unit may be based on a number of active rows of the memory device. In yet another example, the size of the memory unit is based on a page size of one of the active rows. The interleaving of the physical memory locations according to the memory unit size allows memory accesses during AI computations to occur via the dedicated channels to reduce latency and energy consumption.

In act 508, the first processing engine retrieves data from the location of the physical memory components of the memory device via the first set of channels. The retrieved data may include weight matrix data, activation matrix data, and/or other data for performing the AI operation.

In act 510, the first processing engine performs the AI operation based on the data retrieved from the memory device. The first processing engine may perform, for example, a matrix multiplication requested by the AI application to perform the AI operation.

The storing and retrieval of data from memory locations determined by the memory mapping scheme according to one or more embodiments of the present invention may allow the matrix multiplication to be performed with reduced latency and energy consumption, to help enhance performance and responsiveness across a wide range of AI applications, such as, for example, AI application which speed and latency may be a particularly important performance metric. For example, in autonomous vehicle systems, AI tasks or operations such as image classification and object detection may be carried out using deep convolutional neural networks (CNNs) and the like, which access memory locations to perform numerous matrix multiplications across multiple layers to extract and classify features from input images. The retrieval of data from memory locations according to the various embodiments of the present disclosure may reduce the latency associated with such matrix operations, thus reducing the time it takes to analyze high-resolution visual data and output inferences or predictions related to detected images or objects. This improvement in processing speed may support faster detection of traffic signs, pedestrians, other vehicles, and road features, thereby contributing to improved responsiveness and safety in real-time driving scenarios. For example, the speed in which the matrix multiplications are performed may control the speed in which an autonomous vehicle system is controlled to move to avoid collision or other hazardous situations.

In natural language processing (NLP) applications, such as speech-to-text conversion or real-time translation, transformer-based models may perform a large number of matrix multiplications as part of their attention mechanisms and feedforward layers. The retrieval of data from memory locations according to the various embodiments of the present disclosure may help accelerate these matrix multiplications, reducing the latency of token prediction and contextual encoding steps. As a result, translation systems may respond more promptly to incoming speech or text, and thus perform more seamlessly to meet the speed of natural conversation.

In some embodiments, tiled matrix multiplications may also face the problem of increased power consumption in that multiple rows may need to be activated to access the tiles. One or more embodiments of the present disclosure include a tile encoding mechanism to serialize the elements of a tile matrix and save the elements in the PUs 204 in a continuous address space. In this manner a PE 106 may retrieve the tile elements from the PUs 204 via a serialized column accesses. The serialized column accesses may consume less power than multiple row accesses.

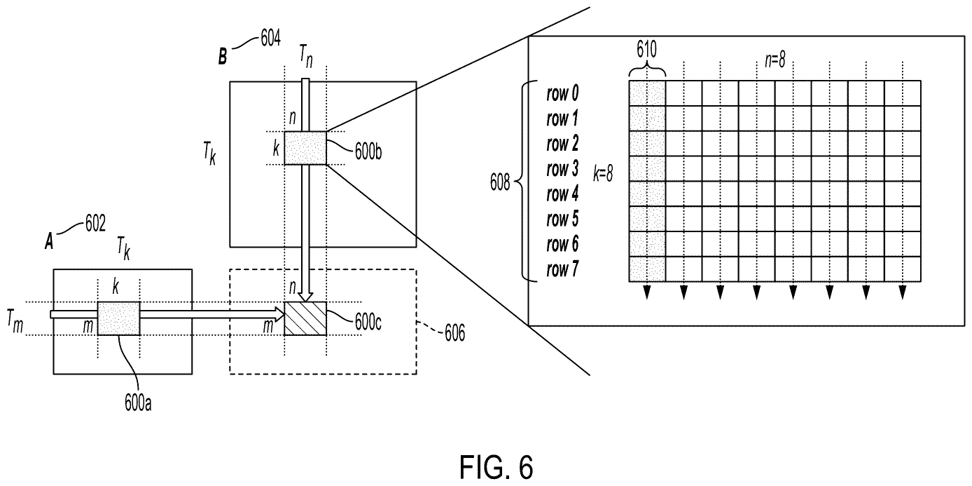

FIG. 6 depicts a conceptual layout diagram of a matrix multiplication of a first matrix (matrix A) 602 with a second matrix (matrix B) 604 to produce a product matrix 606 according to one or more embodiments. For example, matrix A 602 may be a two-dimensional tensor of activations, and matrix B may be a two-dimensional tensor of weights, used for performing an AI (e.g., neural network) operation.

The matrix multiplication may be performed by dividing matrix A 602 and/or matrix B 604 into submatrices or tiles that may be more efficiently processed by a PE 106. For example, a tile 600a of matrix A 602 may be multiplied by a tile 600b of matrix B 604 to generate a tile 600c of the product matrix 606. The matrix multiplication may be performed by calculating dot products of row vectors (e.g., row vectors of size k) of the tile 600b of matrix B 604 of with column vectors (e.g., column vectors of size k) of the tile 600a of matrix A 602. The size of the tiles 600a, 600b may be determined as described in U.S. application Ser. No. 19/251,777, entitled “System and Method for Data Placement for Matrix Multiplication,” filed on Jun. 26, 2025, the content of which is incorporated herein by reference.

In some embodiments, the vectors of the matrix multiplication are read from the memory 104 for performing the matrix multiplication. For example, k rows 608 of the tile 600b with data stored in a column 610 may be retrieved for the tile multiplication. The multiple activations of the rows for accessing relatively small data stored in the column 610 may results in increased power consumption due to the multiple open rows.

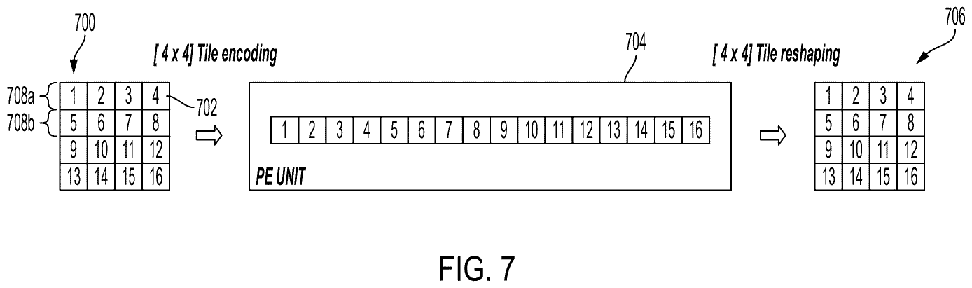

FIG. 7 depicts a conceptual layout diagram of a tile encoding process according to one or more embodiments. The tile encoding process may include serializing elements 702 of a tile 700 to store the elements in consecutive or continuous memory locations of a PU 704. The PU 704 may be similar to the PU 204 of FIG. 2. In this regard, the PU 704 may be mapped to physical memory locations of the memory 104 according to the bit map of FIG. 3. In some embodiments, the bit map may cause the storing of the data across the columns of a row. In this manner a PE 106 performing a matrix multiplication of the tile 700 may retrieve the tiles via serialized column access commands that allow the tile elements to be accessed with less power consumption than multiple row accesses.

In the example of FIG. 7, the tile 700 may be a 4×4 matrix containing 16 elements. A first row 708a of the tile 700 may be stored in a first set of memory locations and a second row 708b of the tile may be stored in a second set of memory locations that may be separated from the first set of memory locations by intervening elements of other tiles. The serializing of the tile 700 may cause the 16 elements of the tile 700 to be stored in continuous memory locations of the PU 704 (e.g., across columns of a row). The serialized elements may be retrieved using serialized column commands, and reshaped to a reshaped 4×4 matrix 706 to perform the tile matrix multiplication.

One or more embodiments of the present disclosure may be implemented in one or more processors. The term processor may refer to one or more processors and/or one or more processing cores. The one or more processors may be hosted in a single device or distributed over multiple devices (e.g. over a cloud system). A processor may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processor, as used herein, each function is performed either by hardware configured, i.e., hard-wired, to perform that function, or by more general-purpose hardware, such as a CPU, configured to execute instructions stored in a non-transitory storage medium (e.g. memory). A processor may be fabricated on a single printed circuit board (PCB) or distributed over several interconnected PCBs. A processor may contain other processing circuits; for example, a processing circuit may include two processing circuits, an FPGA and a CPU, interconnected on a PCB.

It will be understood that, although the terms “first”, “second”, “third”, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed herein could be termed a second element, component, region, layer or section, without departing from the spirit and scope of the inventive concept.

The terminology used herein is for the purpose of describing particular embodiments only and is not intended to be limiting of the inventive concept. Also, unless explicitly stated, the embodiments described herein are not mutually exclusive. Aspects of the embodiments described herein may be combined in some implementations.

As used herein, the terms “substantially,” “about,” and similar terms are used as terms of approximation and not as terms of degree, and are intended to account for the inherent deviations in measured or calculated values that would be recognized by those of ordinary skill in the art.

As used herein, the singular forms “a” and “an” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the inventive concept refers to “one or more embodiments of the present disclosure”. Also, the term “exemplary” is intended to refer to an example or illustration. As used herein, the terms “use,” “using,” and “used” may be considered synonymous with the terms “utilize,” “utilizing,” and “utilized,” respectively.

Although exemplary embodiments of systems and methods for address mapping of a memory device have been specifically described and illustrated herein, many modifications and variations will be apparent to those skilled in the art. Accordingly, it is to be understood that systems and methods for address mapping of a memory device constructed according to principles of this disclosure may be embodied other than as specifically described herein. The disclosure is also defined in the following claims, and equivalents thereof.

The systems and methods for address mapping of a memory device may contain one or more combination of features set forth in the below statements.

### Statement 1

An apparatus comprising: a memory device organized into a plurality of memory units, wherein memory addresses of the memory device are interleaved across the memory units; a first processing engine associated with a first set of channels configured to access the memory device, wherein the first processing engine is associated with a first memory unit of the plurality of memory units, wherein a size of the first memory unit is based on a number of channels in the first set of channels, the first processing engine being configured to: receive a request associated with an artificial intelligence (AI) operation, the request including a first memory address; identify, based on the first memory address, a memory location defined by physical memory components of the memory device, wherein the memory location is contained in the first memory unit; retrieve data from the memory device based on the memory location via one or more of the first set of channels; and perform the AI operation based on the data retrieved from the memory device.

### Statement 2

The apparatus of Statement 1, wherein the size of the first memory unit is based on a number of active rows of the memory device.

### Statement 3

The apparatus of Statement 2, wherein the size of the first memory unit is based on a page size of one of the active rows.

### Statement 4

The apparatus of Statement 1, wherein the AI operation invokes a matrix multiplication.

### Statement 5

The apparatus of Statement 1, wherein the memory device includes two or more memory dies configured to be vertically stacked on top of each other.

### Statement 6

The apparatus of Statement 1, wherein a second processing engine is associated with a second memory unit, wherein the second memory unit has a second memory address greater than the first memory address by a size of the memory unit.

### Statement 7

The apparatus of Statement 1, wherein the first memory address is mapped to one or more fields of the memory location defined by the physical memory components, wherein the fields include at least one of an offset field, a bank group field, a column field, and a channel field.

### Statement 8

The apparatus of Statement 7, wherein the one or more fields have locations relative to each other to control access of first columns in a first row relative to access of second columns in a second row.

### Statement 9

The apparatus of Statement 7, wherein the one or more fields have locations relative to each other to provide interleaved row access across bank groups.

### Statement 10

The apparatus of Statement 7, wherein the one or more fields have locations relative to each other to provide interleaved channel access across the first set of channels.

### Statement 11

A method comprising: receiving, by a processing engine, a request associated with an artificial intelligence (AI) operation, the request including a first memory address, wherein the first processing engine associated with a first set of channels configured to access a memory device, wherein the memory device is organized into a plurality of memory units, wherein memory addresses of the memory device are interleaved across the memory units, and wherein the first processing engine is associated with a first memory unit of the plurality of memory units, wherein a size of the first memory unit is based on a number of channels in the first set of channels; identifying, based on the first memory address, a memory location defined by physical memory components of the memory device, wherein the memory location is contained in the first memory unit; retrieving data from the memory device based on the memory location via one or more of a first set of channels; and performing the AI operation based on the data retrieved from the memory device.

### Statement 12

The method of Statement 11, wherein the size of the first memory unit is based on a number of active rows of the memory device.

### Statement 13

The method of Statement 12, wherein the size of the first memory unit is based on a page size of one of the active rows.

### Statement 14

The method of Statement 11, wherein the AI operation invokes a matrix multiplication.

### Statement 15

The method of Statement 11, wherein the memory device includes two or more memory dies configured to be vertically stacked on top of each other.

### Statement 16

The method of Statement 11, wherein a second processing engine is associated with a second memory unit, wherein the second memory unit has a second memory address greater than the first memory address by a size of the memory unit.

### Statement 17

The method of Statement 11, wherein the first memory address is mapped to one or more fields of the memory location defined by the physical memory components, wherein the fields include at least one of an offset field, a bank group field, a column field, and a channel field.

### Statement 18

The method of Statement 17, wherein the one or more fields have locations relative to each other to control access of first columns in a first row relative to access of second columns in a second row.

### Statement 19

The method of Statement 17, wherein the one or more fields have locations relative to each other to provide interleaved row access across bank groups.

### Statement 20

The method of Statement 17, wherein the one or more fields have locations relative to each other to provide interleaved channel access across the first set of channels.

What is claimed is:

1. An apparatus comprising:
a memory device organized into a plurality of memory units, wherein memory addresses of the memory device are interleaved across the memory units;
a first processing engine associated with a first set of channels configured to access the memory device, wherein the first processing engine is associated with a first memory unit of the plurality of memory units, wherein a size of the first memory unit is based on a number of channels in the first set of channels, the first processing engine being configured to:
receive a request associated with an artificial intelligence (AI) operation, the request including a first memory address;
identify, based on the first memory address, a memory location defined by physical memory components of the memory device, wherein the memory location is contained in the first memory unit;
retrieve data from the memory device based on the memory location via one or more of the first set of channels; and
perform the AI operation based on the data retrieved from the memory device.

2. The apparatus of claim 1, wherein the size of the first memory unit is based on a number of active rows of the memory device.

3. The apparatus of claim 2, wherein the size of the first memory unit is based on a page size of one of the active rows.

4. The apparatus of claim 1, wherein the AI operation invokes a matrix multiplication.

5. The apparatus of claim 1, wherein the memory device includes two or more memory dies configured to be vertically stacked on top of each other.

6. The apparatus of claim 1, wherein a second processing engine is associated with a second memory unit, wherein the second memory unit has a second memory address greater than the first memory address by a size of the memory unit.

7. The apparatus of claim 1, wherein the first memory address is mapped to one or more fields of the memory location defined by the physical memory components, wherein the fields include at least one of an offset field, a bank group field, a column field, and a channel field.

8. The apparatus of claim 7, wherein the one or more fields have locations relative to each other to control access of first columns in a first row relative to access of second columns in a second row.

9. The apparatus of claim 7, wherein the one or more fields have locations relative to each other to provide interleaved row access across bank groups.

10. The apparatus of claim 7, wherein the one or more fields have locations relative to each other to provide interleaved channel access across the first set of channels.

11. A method comprising:
receiving, by a processing engine, a request associated with an artificial intelligence (AI) operation, the request including a first memory address, wherein the first processing engine associated with a first set of channels configured to access a memory device, wherein the memory device is organized into a plurality of memory units, wherein memory addresses of the memory device are interleaved across the memory units, and wherein the first processing engine is associated with a first memory unit of the plurality of memory units, wherein a size of the first memory unit is based on a number of channels in the first set of channels;
identifying, based on the first memory address, a memory location defined by physical memory components of the memory device, wherein the memory location is contained in the first memory unit;
retrieving data from the memory device based on the memory location via one or more of a first set of channels; and
performing the AI operation based on the data retrieved from the memory device.

12. The method of claim 11, wherein the size of the first memory unit is based on a number of active rows of the memory device.

13. The method of claim 12, wherein the size of the first memory unit is based on a page size of one of the active rows.

14. The method of claim 11, wherein the AI operation invokes a matrix multiplication.

15. The method of claim 11, wherein the memory device includes two or more memory dies configured to be vertically stacked on top of each other.

16. The method of claim 11, wherein a second processing engine is associated with a second memory unit, wherein the second memory unit has a second memory address greater than the first memory address by a size of the memory unit.

17. The method of claim 11, wherein the first memory address is mapped to one or more fields of the memory location defined by the physical memory components, wherein the fields include at least one of an offset field, a bank group field, a column field, and a channel field.

18. The method of claim 17, wherein the one or more fields have locations relative to each other to control access of first columns in a first row relative to access of second columns in a second row.

19. The method of claim 17, wherein the one or more fields have locations relative to each other to provide interleaved row access across bank groups.

20. The method of claim 17, wherein the one or more fields have locations relative to each other to provide interleaved channel access across the first set of channels.
